(19) United States
(12) Patent Application Publication
(10) Pub. No.: US 2012/0124253 A1
(43) Pub. Date: May 17, 2012

(54) SWITCH CIRCUIT AND METHOD FOR SWITCHING INPUT/OUTPUT PORT AND ELECTRONIC DEVICE USING THE SAME

(76) Inventor: Hsu-Hung CHENG, Taipei (TW)

(21) Appl. No.: 13/292,462

(22) Filed: Nov. 9, 2011

(30) Foreign Application Priority Data
Nov. 12, 2010 (CN) 201010541751.6

(51) Int. Cl. G06F 3/00

(52) U.S. Cl. 710/38

(57) ABSTRACT

A switch circuit for switching input/output port includes a control unit, a built-in input/output (I/O) port, an external I/O port and a switch unit. The switch unit is electrically connected to the control unit, the built-in I/O port and the external I/O port. The switch unit receives a control signal and selectively forms a channel between the control unit and the built-in I/O port or between the control unit and the external I/O port accordingly.

### CROSS REFERENCE TO RELATED APPLICATIONS

This Non-provisional application claims priority under 35 U.S.C. §119(a) on Patent Application No(s). 201010541751.6 filed in People's Republic of China on Nov. 12, 2010, the entire contents of which are hereby incorporated by reference.

### BACKGROUND OF THE INVENTION

1. Field of Invention

The invention relates to a switch circuit for switching an input/output port and a method thereof and, more particularly, to a switch circuit capable of switching between a built-in input/output (I/O) port and an external I/O port and a method thereof.

2. Related Art

A motherboard is used as a platform to connect components in a computer together. In general, a central processing unit (CPU) is like a brain which responsible for calculation, and the motherboard is like a spine that connects expansion cards, a hard disk, network, an audio device, a keyboard, a mouse, a printer and other peripheral devices to the CPU to control.

In conventional computer system architecture, multiple connection interface technologies, such as accelerated graphics port (AGP) bus technology of a graphic card, serial advanced technology attachment (SATA) technology of a hard disk storage device and a peripheral controller interface (PCI) technology of other devices, are used to meet different requirements. Moreover, with development of the computer technology, requirements on the system bandwidth and transmission speed are higher. Consequently, PCIe with a higher speed is launched, and it almost can take place of all conventional built-in buses (including AGP and PCI).

Generally, SATA is only available for use in the computer casing. To expand storage capacity externally, the user needs to open the computer casing, and install or replace a hard disk with larger capacity, which is quite inconvenience for users. Thus, external SATA (eSATA) is developed. eSATA extends the built-in SATA to the external storage device, and multiple cost-effective external storage application modes are achieved. It can improve the storage capacity and reinforce data protection.

A conventional eSATA function is usually provided in three modes. In a first mode, the eSATA cooperates with an independent control chip, and however, the manufacture cost is increased. In a second mode, a built-in SATA interface of a south bridge chip is connected to a back panel of the computer casing to be used as an eSATA port. In a third mode, the built-in SATA port is converted to the eSATA port via a SATA-to-eSATA cable. However, the available built-in SATA port is occupied in the second and third modes, and thus less built-in devices can be installed. Moreover, since the number of the channel of the PCIe interface supported by the south bridge chip is limited, if the number of the built-in SATA port and the eSATA port is increased, the limited channel number of the PCIe interface is occupied.

### SUMMARY OF THE INVENTION

A switch circuit of an I/O port and a method thereof for switching between a built-in I/O port and an external I/O port are disclosed.

The switch circuit of the I/O port includes a control unit, a built-in I/O port, an external I/O port and a switch unit. The switch unit is electrically connected to the control unit, the built-in I/O port and the external I/O port. The switch unit receives a control signal and selectively forms a channel between the control unit and the built-in I/O port or between the control unit and the external I/O port accordingly.

The method of the I/O port includes following steps: inputting a control signal to a switch unit which is electronically connected to a control unit, a built-in I/O port and an external I/O port; and forming a channel between the control unit and the built-in I/O port or between the control unit and the external I/O port selectively by the switch unit according to the control signal.

An electronic device is also disclosed herein, which includes a casing and a motherboard. The motherboard is disposed in the casing. The motherboard includes a control unit, a built-in I/O port, an external I/O port and a switch unit. The external I/O port is exposed form the casing. The switch unit is electronically connected to the control unit, the built-in I/O port and the external I/O port. The switch unit receives a control signal and selectively forms a channel between the control unit and the built-in I/O port or between the control unit and the external I/O port accordingly.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing an electronic device in an embodiment;

FIG. 2 is a schematic diagram showing a motherboard in an embodiment; and

FIG. 3 is a flow chart showing a method for switching an I/O port in an embodiment.

### DETAILED DESCRIPTION OF THE INVENTION

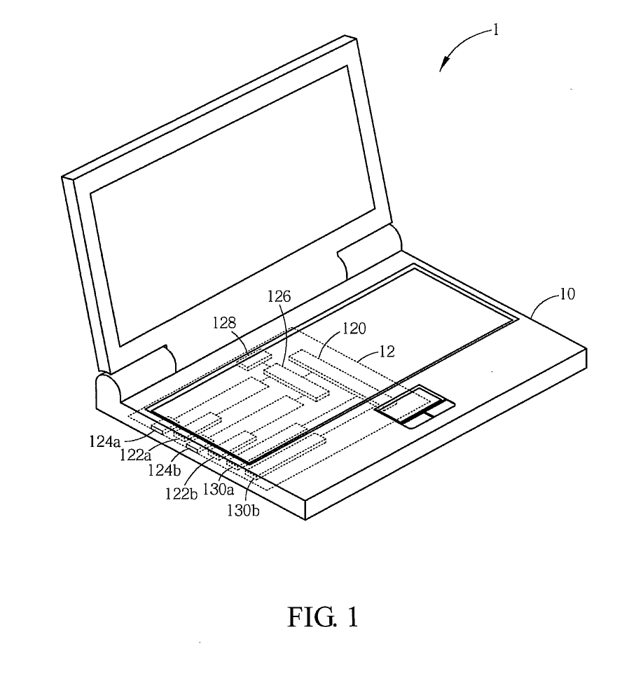

FIG. 1 is a schematic diagram showing an electronic device in an embodiment. Hereinafter, a notebook is taken as an example of an electronic device 1, which is not limited herein. The electronic device 1 includes a casing 10 and a motherboard 12. The motherboard 12 is disposed in the casing 10. In general, except motherboard 12, the casing 10 also includes other electronic components (not shown) with different functions, such as a fan, a hard disk, an optical disk drive (ODD) and a power supply. The function of the electronic components can be achieved by persons having ordinary skill in the art, which is omitted herein.

As shown in FIG. 1, the motherboard 12 includes a control unit 120, built-in I/O ports 122a and 122b, external I/O ports 124a and 124b, a switch unit 126, a driver 128 and expansion card slots 130a and 130b, where the control unit 120, the built-in I/O ports 122a and 122b, the external I/O ports 124a and 124b, the switch unit 126 and the driver 128 form the switch circuit of the I/O port. The switch unit 126 is electrically connected to the control unit 120, the built-in I/O ports 122a, 122b, the external I/O ports 124a, 124b, and the driver 128, and the expansion card slots 130a and 130b are electrically connected to the control unit 120. Although some necessary components, such as network, an audio device and even a display chip are built in the motherboard, the motherboard still has expansion requirements. The expansion card slots 130a and 130b are used for inserting other expansion cards, such as a television card, a wireless network card or a high-level display card.

Except the above components above, the motherboard 12 also includes a socket for disposing a central processing unit (CPU), a north bridge chip, a south bridge chip, a basic input/output system (BIOS) and a power connector. The function of the above components can be achieved and applied by persons having ordinary skills in the art, which is omitted herein.

In the embodiment, the built-in I/O ports 122a, 122b and the external I/O ports 124a, 124b may meet SATA specification, universal serial bus (USB) specification or fiber channel (FC) specification. For example, the built-in I/O ports 122a, 122b may be built-in SATA ports for connecting a SATA hard disk (not shown) disposed in the casing 10. The external I/O ports 124a, 124b may be eSATA ports for connecting an external SATA hard disk. As shown in FIG. 1, when the motherboard 12 is disposed in the casing 10, the external I/O ports 124a, 124b are exposed from the casing 10. Consequently, the user can connect the external electronic device to the external I/O ports 124a, 124b or disconnect the external electronic device from the external I/O ports 124a, 124b.

In an embodiment, the switch unit 126 receives a control signal and selectively forms a channel between the control unit 120 and the built-in I/O ports 122a, 122b or between the control unit 120 and the external I/O ports 124a, 124b accordingly. For example, when the external I/O port 124a is idle (that is, no external electronic device is connected to the external I/O port 124a), the driver 128 outputs the control signal to control the switch unit 126 to form a channel between the control unit 120 and the built-in I/O port 122a. Additionally, an open circuit is formed between the control unit 120 and the external I/O port 124a.

On the other hand, when the user connects the external electronic device to the external I/O port 124a, the driver 128 generates an inquiry window at the operating system to inquire whether to form a channel between the control unit 120 and the external I/O port 124a. If the user selects “no”, the switch unit 126 keeps the channel formed between the control unit 120 and the built-in I/O port 122a. On the contrary, if the user selects “yes”, the driver 128 outputs the control signal to control the switch unit 126 to form a channel between the control unit 120 and the external I/O port 124a. Additionally, an open circuit is formed between the control unit 120 and the built-in I/O port 122a.

When the user removes the external electronic device from the external I/O port 124a, no matter whether the built-in I/O port 122a is connected to a device or not, the driver 128 outputs the control signal to control the switch unit 126 to form a channel between the control unit 120 and the built-in I/O port 122a, and an open circuit is formed between the control unit 120 and the external I/O port 124a.

Similarly, the switch between the built-in I/O port 122b and the external I/O port 124b also may be switched based on the switch mechanism described above, which is omitted herein.

The driver 128 may be performed via software programs, and the control unit 120 may be the south bridge chip. Consequently, except for the limited built-in I/O ports, the number of the available external I/O ports is increased without an additional control chip.

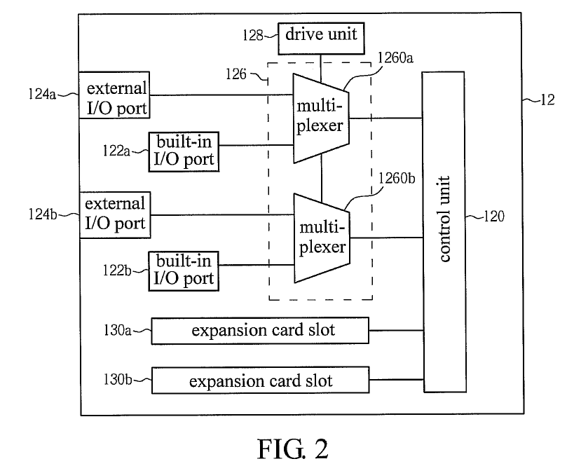

FIG. 2 is a schematic diagram showing a motherboard in an embodiment. The switch unit 126 may include multiplexers 1260a, 1260b which selectively form a channel between the control unit 120 and the built-in I/O ports 122a, 122b or between the control unit 120 and the external I/O ports 124a, 124b according to the control signal outputted by the driver 128. For example, if the multiplexer 1260a receives a high-level control signal, the multiplexer 1260a forms a channel between the control unit 120 and the built-in I/O port 122a. If the multiplexer 1260a receives a low-level control signal, the multiplexer 1260a forms a channel between the control unit 120 and the external I/O port 124a.

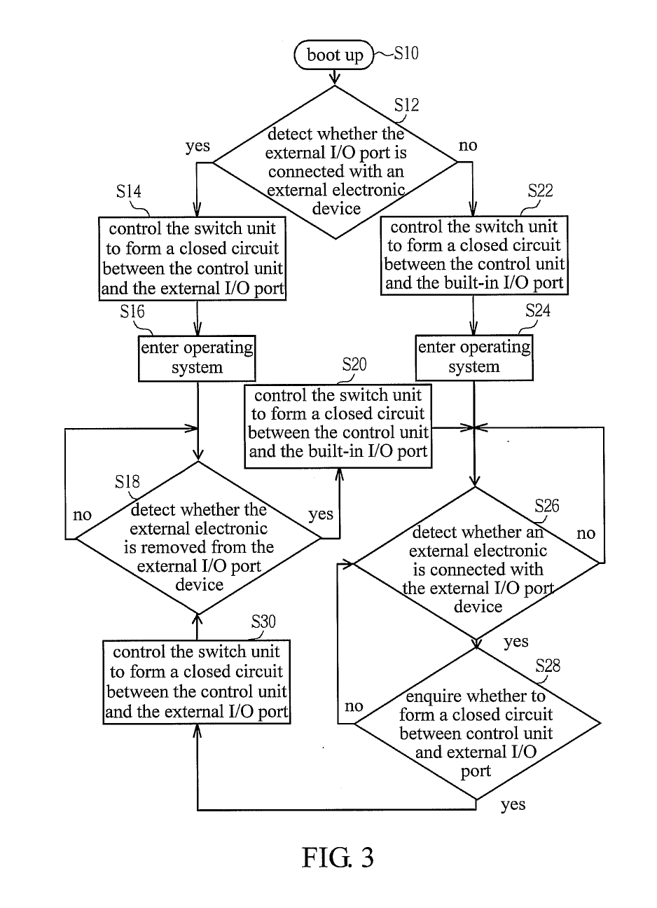

FIG. 3 is a flow chart showing a method for switching an I/O port in an embodiment. Please also refer to FIG. 1 and FIG. 2. The method for switching the I/O port includes the following steps. First, boot the electronic device 1 (Step S10). Then, detect whether the external I/O port 124a, 124b is connected with an external electronic device (Step S12). If the detection result in Step S12 is “yes”, the driver 128 outputs a control signal to control the switch unit 126 to form a channel between the control unit 120 and the external I/O port 124a , 124b (Step S14) correspondingly, and the electronic device 1 enters the operating system (Step S16). Next, detect whether the external electronic device is removed from the external I/O port 124a, 124b (Step S18). If the detection result in Step S18 is “no”, Step S18 is repeated. If the detection result in Step S18 is “yes”, the driver 128 outputs the control signal to control the switch unit 126 to form a channel between the control unit 120 and the built-in I/O port 122a or 122b correspondingly (Step S20).

If the detection result in Step S12 is “no”, the driver 128 outputs the control signal to control the switch unit 126 to form a channel between the control unit 120 and the built-in I/O port 122a, 122b (Step S22), and the electronic device 1 enters the operating system (Step S24). And detect whether the external electronic device is connected to the external I/O port 124a, 124b (Step S26). If the detection result in Step S26 is “no”, Step S26 is repeated. If the detection result in Step S26 is “yes”, the driver 128 generates an inquiry window to inquire whether to form a channel between the control unit 120 and the external I/O port 124a, 124b (Step S28). If the user selects “no” in Step S28, Step S26 is repeated. If the user selects “yes” in Step S28, the driver 128 outputs the control signal to control the switch unit 126 to form a channel between the control unit 120 and the external I/O port 124a, 124b (Step S30) correspondingly, and Step S18 is repeated.

Compared to conventional technology, a switch unit is used for selectively forming a channel between a control unit and a built-in I/O port or between a control unit and an external I/O port. Thus, the number of the available external I/O ports is increased in the limited built-in I/O ports without using a transmission cable, occupying the limited channel of the PCIe, and installing additional control chips at the motherboard.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A switch circuit of an input/output (I/O) port, comprising:
a control unit;
a built-in I/O port;
an external I/O port; and
a switch unit electrically connected to the control unit, the built-in I/O port and the external I/O port, wherein the switch unit receives a control signal and selectively forms a channel between the control unit and the built-in I/O port or between the control unit and the external I/O port accordingly.

2. The switch circuit of the I/O port according to claim 1, wherein the built-in I/O port and the external I/O port respectively meets: serial advanced technology attachment (SATA) specification, universal serial bus (USB) specification or fiber channel (FC) specification.

3. The switch circuit of the I/O port according to claim 1, wherein the switch unit includes a multiplexer which selectively forms a channel between the control unit and the built-in I/O port or between the control unit and the external I/O port according to the control signal.

4. The switch circuit of the I/O port according to claim 1, wherein the switch circuit further includes a driver electrically connected to the switch unit, and when the external I/O port is idle, the driver outputs the control signal to control the switch unit to form a channel between the control unit and the built-in I/O port.

5. The switch circuit of the I/O port according to claim 4, wherein when an external electronic device is connected to the external I/O port, the driver generates an inquiry window enquiring whether to form a channel between the control unit and the external I/O port.

6. The switch circuit of the I/O port according to claim 5, wherein when the external electronic device is removed from the external I/O port, the driver outputs the control signal to control the switch unit to form a channel between the control unit and the built-in I/O port.

7. An electronic device, comprising:
a casing; and
a motherboard disposed in the casing, and the motherboard including:
a control unit;
a built-in I/O port;
an external I/O port exposed from the casing; and
a switch unit electronically connected to the control unit, the built-in I/O port and the external I/O port, wherein the switch unit receives a control signal and selectively forms a channel between the control unit and the built-in I/O port or between the control unit and the external I/O port accordingly.

8. The electronic device according to claim 7, wherein the built-in I/O port and the external I/O port respectively meets SATA specification, USB specification or FC specification.

9. The electronic device according to claim 7, wherein the switch unit includes a multiplexer which selectively forms a channel between the control unit and the built-in I/O port or between the control unit and the external I/O port according to the control signal.

10. The electronic device according to claim 7, wherein the motherboard further includes a driver electrically connected to the switch unit, and when the external I/O port is idle, the driver outputs the control signal to control the switch unit to form a channel between the control unit and the built-in I/O port.

11. The electronic device according to claim 10, wherein when an external electronic device is connected to the external I/O port, the driver generates an inquiry window enquiring whether to form a channel between the control unit and the external I/O port.

12. The electronic device according to claim 11, wherein when the external electronic device is removed from the external I/O port, the driver outputs the control signal to control the switch unit to form a channel between the control unit and the built-in I/O port.

13. A method for switching an I/O port, comprising:
inputting a control signal to a switch unit which is electronically connected to a control unit, a built-in I/O port and an external I/O port; and
forming a channel between the control unit and the built-in I/O port or between the control unit and the external I/O port selectively by the switch unit according to the control signal.

14. The method for switching the I/O port according to claim 13, wherein the built-in I/O port and the external I/O port respectively meets SATA specification, USB specification or FC specification.

15. The method for switching the I/O port according to claim 13, wherein the switch unit includes a multiplexer, and the method for switching the I/O port further includes:
forming a channel between the control unit and the built-in I/O port or between the control unit and the external I/O port selectively by the multiplexer according to the control signal.

16. The method for switching the I/O port according to claim 13, wherein a driver is electronically connected to the switch unit, and the method for switching the I/O port further includes:
outputting the control signal by the driver to control the switch unit to form a channel between the control unit and the built-in I/O port when the external I/O port is idle.

17. The method for switching the I/O port according to claim 13, further comprising:
generating an inquiry window by the driver for enquiring whether to form a channel between the control unit and the external I/O port when an external electronic device is connected to the external I/O port.

18. The method for switching the I/O port according to claim 17, further comprising:
outputting the control signal by the driver to control the switch unit to form a channel between the control unit and the built-in I/O port when the external electronic device is removed from the external I/O port.
